(19) United States
(12) Patent Application Publication
(10) Pub. No.: US 2026/0249881 A1
(43) Pub. Date: Aug. 27, 2026

(54) System and method to protect a car from road deformities and objects

(71) Applicant: Alex C. Chen, Mountain View, CA (US)

(72) Inventor: Alex C. Chen, Mountain View, CA (US)

(21) Appl. No.: 19/729,046

(22) Filed: Feb. 21, 2026

Related U.S. Application Data
(60) Provisional application No. 63/762,085, filed on Feb. 23, 2025.

(51) Int. Cl. B60W 60/00; B60W 10/20; B60W 50/00; B60W 50/08; B60W 50/14

(52) U.S. Cl. CPC B60W 60/0011; B60W 10/20; B60W 50/0097; B60W 50/085; B60W 50/14; B60W 2050/146; B60W 2520/10; B60W 2540/215; B60W 2552/35; B60W 2554/20; B60W 2556/65; B60W 2710/20; B60W 2720/106

(57) ABSTRACT

A car may have systems and methods to protect a car from deformities and objects on the road or in the air. One system may detect deformities and objects, warn the driver, slow down, and/or steer the car to avoid hitting deformities and objects on the road. Another system may generate an air blast, activate a windshield wiper and/or activate a water sprayer to deflect an object before it hits the windshield of the car.

### CLAIM OF PRIORITY

This patent application claims priority to U.S. Provisional Application No. 63/762,085 filed on Feb. 23, 2025.

### BACKGROUND

When cars drive over deformities in the road (such as pot holes and cracks) or objects on the road (such as rocks, nails, glass, gardening tools, construction materials, such as wood, concrete, metal, furniture, tree branches, dead animals, or other debris), cars can suffer tire punctures, flat tires, tire bulges, fender damage, car body damage, and other damage (shock absorbers and tire/wheel misalignment). Passengers in a car may also be injured.

Cars also suffer cracked windshields from rocks or gravel hitting the windshield, usually from trucks carrying rocks or gravel, or truck tires that kick up rocks and gravel into the air.

Fixing or replacing tires, wheel alignment, and windshields can be expensive and time consuming to car owners.

### BRIEF DESCRIPTION OF THE FIGURES

FIG. 1 shows a car with sensors to detect a deformity and/or an object in the road in front of the car.

FIG. 2 shows hardware and software components of the car in FIG. 1.

FIG. 3 shows a front tire of the car in FIG. 1 swerving to the left to avoid driving over a part of a deformity or object.

FIG. 4 shows a display of the car in FIG. 1.

FIG. 5 shows a method that may be performed by the car in FIG. 1.

### DESCRIPTION

FIG. 1 shows a car 100 with sensors 102A, 102B to detect a deformity 152 in the road 150 and/or an object 154 on the road 150 in front of the car 100 as the car 100 is driving forward. The car 100 may be a Tesla, Rivian, Waymo, Nuro, a truck, a motorcycle, a 3-wheel vehicle, a plane, a hovercraft, or any type of vehicle. The car 100 may be electric-powered, gas-powered, hydrogen-powered, or a hybrid.

Some cars made by Tesla have a software and hardware package called supervised full-self driving (FSD)(also called autonomous driving), which allows a car to drive itself toward a destination set by the user. These Teslas recognize stop signs, traffic lights, and other cars on the road, and adjust their speed according to a car in front of the Tesla. But Tesla cars do not detect objects and deformities on the road, and slow down or swerve to avoid the objects and deformities. The hardware and software described below may be useful to cars with autonomous driving and cars without autonomous driving.

At a high level, in FIG. 1, a processor 104 in a car 100 may analyze data/information captured by sensors 102A, 102B on the car 100 and balance or consider multiple objectives, such as:
1) steer the car 100 to avoid deformities 152 and objects 154 on the road 150, which protects the car components, such as tires, alignment, shock absorbers, etc.;
2) maintain a smooth ride of the car 100 for the comfort of passengers by avoiding abrupt swerving and/or braking; and
3) protect other cars, bicyclists, and pedestrians on the road 150 or near the road 150.

### Sensors

FIG. 1 shows a car 100 with one or more sensors 102A, 102B, which may be set in any location or position on the car 100, such as the front of the car 100, inside the car 100, above the windshield, or on top of the car 100. The car 100 may have one or more types of sensors, such as cameras (to capture images and/or videos), radar, ultrasonics, LIDAR (Light Detection and Ranging), infrared, and microphones. One embodiment of the car 100 only has cameras, while another embodiment of the car 100 has multiple types of sensors. There are many types of cameras that can be used. Other types of sensors may be built into or added to the car 100 in addition to or instead of the sensors described here.

The sensors 102 may sense the road 150, a deformity 152 in the road 150 (such as a pothole, crack, repair, plate, speed bump, or uneven surface), an object 154 on the road 150 (such as a rock, nail, glass, gardening tool, cardboard, construction material (e.g., wood, concrete, metal), furniture, plant, tree branch, live or dead animal, traffic cone, or debris) in front of the car 100, and/or an object 156 in the air, such as a rock or gravel that on a trajectory to hit a part of the car 100, such as the windshield.

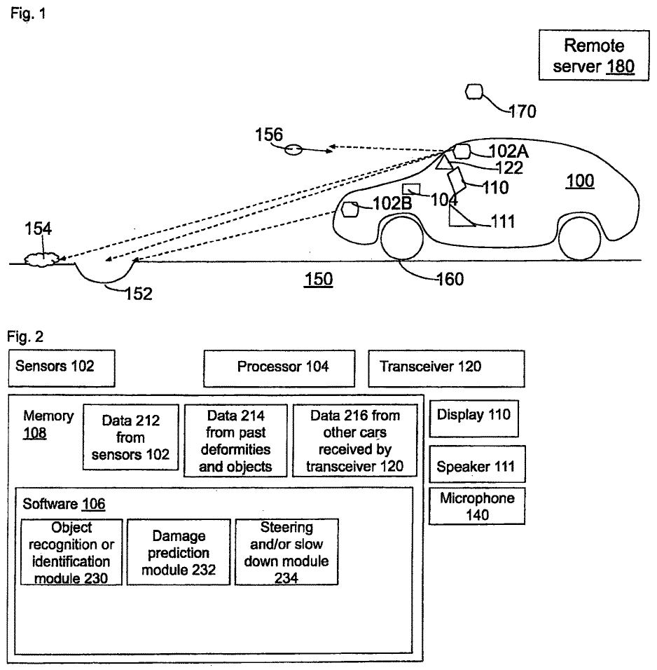

In one embodiment, there are at least 2 sensors 102B, such as left and right cameras positioned near the 2 headlights of the car 100, to capture a stereoscopic image or video of an object 154, which may help an object recognition or identification module 230 (FIG. 2) better recognize or identify the object 154 or deformity 152.

The sensors 102A, 102B may automatically or manually change their position (angle) and/or range, depending on one or more factors, such as the speed of the car 100, weather conditions (e.g., rain, snow, sleet, ice, fog, temperature, humidity), amount of light (sunlight or street lamps), and time of day (day or night). For example, if the car 100 is driving relatively slow (e.g., 15 miles per hour), then the sensors 102 may detect a deformity 152 and/or object 154 relatively close (e.g., 10-20 feet) to the car 100, potentially with greater accuracy. If the car 100 is driving relatively fast (e.g., 65 mph), the sensors 102 may adjust their angle and/or range to detect a deformity 152 and/or object 154 relatively far (e.g., 30-60 feet) from the car 100.

### Processor and Software

FIGS. 1 and 2 show hardware and software components inside the car 100. The sensors 102 may be connected to (wired) or in communication (wireless) with the processor 104 in the car 100. The processor 104 may be a single processor or multiple processors or a system on chip (SOC). The processor 104 may be made by Nvidia, Intel, AMD, Mediatek, Broadcom, Qualcomm, or other manufacturer.

The processor 104 may execute software 106 (stored on a memory 108) to detect and analyze the deformity 152 or object 154 on the road 100 and decide how to respond. The word “processor,” as used herein, may refer to a combination of hardware and software.

In another embodiment, the processor 104 may send images and videos of the deformity 152 and object 154 via a transceiver 120 to a remote server 180 to 1) analyze and identify the deformity 154 and object 154 and 2) send information or instructions back to the car 100. The transceiver 120 may be a 4G, 5G, or 6G transceiver configured to communicate with a network.

In FIG. 2, the software modules 230, 232, 234 are described below as separate modules, but they may be combined or integrated within one software module. Any of the modules 230, 232, 234 in software 106 in FIG. 2 may include or use artificial intelligence (AI) algorithms and agents to identify objects and deformities on the road, predict an amount of damage that the objects and deformities may cause to the car 100, and steer and/or slow down the car 100.

In FIG. 2, a microphone 140 may receive voice commands from a user to control the software 106, such as slow down, swerve left, or swerve right.

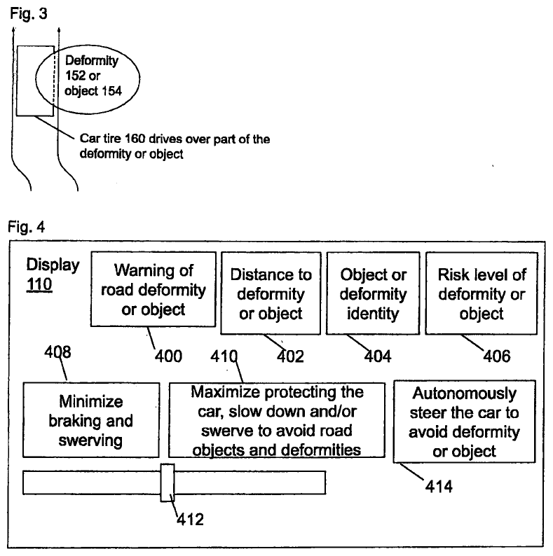

FIG. 3 shows a front tire of the car in FIG. 1 swerving to the left to avoid driving over a part of a deformity 152 or object 154.

FIG. 4 shows a display 110 of the car 100 in FIG. 1, including examples of information and user options to display to the driver of the car 100.

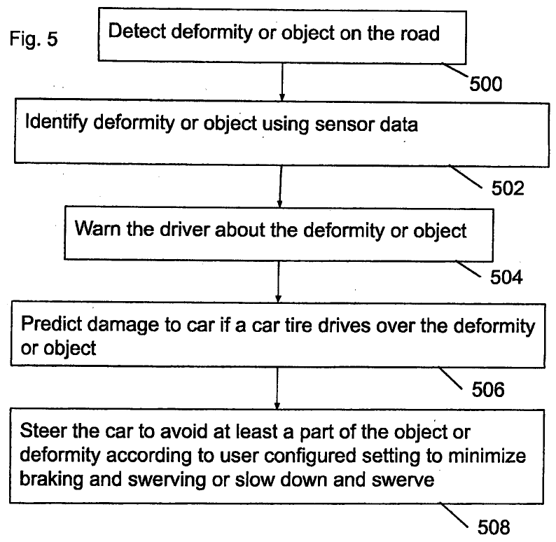

FIG. 5 shows a method that may be performed by the car 100 in FIG. 1. The actions in FIG. 5 may be performed in any order, at different times, or at the same time, depending on preferences of the car manufacturer and user-configurable settings. For example, block 506 (predicting damage) may be performed before block 504 (warn the driver). As another example, block 508 (steer the car) may be performed before or at the same time as block 504 (warn the driver).

FIG. 5 will now be described at high level, and then each action in FIG. 5 will be described in more detail below.

In block 500 of FIG. 5, the processor 104 (FIG. 2) analyzes data 212 (FIG. 2)(such as videos and images) from sensors 102A, 102B (FIG. 1) to detect a deformity 152 or object 154 on the road 150.

In block 502 of FIG. 5, object recognition/identification module 230 (FIG. 2) detects and tries to identify or recognize the deformity 152 or object 154 on the road 150.

In block 504 of FIG. 5, the processor 104 may cause the display 110 to display a warning 400 (FIG. 4) to the driver.

In block 506 of FIG. 5, damage prediction module 232 (FIG. 2) may assess a level of risk of the deformity 152 or object 154 and predict an amount of damage that a car tire 160 may suffer from the deformity 152 or object 154.

In block 508, the module 414 steers the car 100 to avoid at least a part of the object 154 or deformity 152 according to a user configured setting 412 (FIG. 4) to minimize braking and swerving 408 or maximizing protecting the car by slowing down and swerving 410.

### Identify or Recognize the Deformity or Object

In FIG. 2, the processor 104 may execute object recognition or identification module 230 to try to identify the deformity 152, object 154, or a characteristic of the deformity 152 or object 154 (e.g., reflect light, sharp edges, stiffness). The object identification module 230 may use data (such as images or videos) collected by multiple sensors, such as a left camera and a right camera on the front of the car, where 2 images can be combined to form a stereoscopic image, which may help the module 230 better identify the object 154 or deformity 152 and assess its level of risk.

The object identification module 230 may use a database 214 of data collected from previously encountered deformities and/or objects by the car 100. The module 230 may use data 216 from other cars stored on the memory 108 or received by the transceiver 120. The object recognition module 230 may accurately identify a deformity 152 or object 154, or narrow down the possible deformities or objects to 2 or 3 things. Processors and software to recognize objects are described in applicants' previously-filed patent applications, such as U.S. Pat. Nos. 7,450,960 and 9,500,865, which are hereby incorporated by reference in their entirety.

The modules 230 and 232 may have limited time (1-2 seconds or less) to identify an object or deformity and predict damage. The processor 104 may cause the car 100 to turn on high beam lights for the sensors 102 to capture more data or better data, and help the module 230 identify the object 154 or deformity 152 quicker or more accurately, and help the module 232 predict damage quicker or more accurately.

### Predict Damage to Car Tire

In FIG. 2, the processor 104 may execute damage prediction module 232 to assess the hardness, stiffness, and sharpness of the deformity 152 or object 154 to predict an amount of damage to a car tire if the car tire hits the deformity 152 or object 154. The module 232 may determine if the predicted level of damage is above a threshold, such as low, medium or high. The damage prediction module 232 may consider characteristics of the car tire (described above). The processor 104 may use artificial intelligence (AI), machine learning, and data 212 from the car 100 itself, data 214 based on previous deformities and/or objects encountered by the car 100, and/or data 216 from other cars to predict the level of damage if a car tire 160 hits the deformity 152 or object 154.

The processor 104 may use steering and slow down module 234 to decide whether the car 100 should steer to avoid, steer to partially avoid, or slow down and completely avoid the deformity 152 or object 154.

For example, if the damage prediction module 232 predicts the car tire 160 driving over a deformity 152, such as a large, deep hole (e.g., more than 6 inches deep, more than 10 inches in diameter), or an object 154, such as a large nail or broken glass, will be damaged (medium risk of a flat tire), i.e., above a low threshold, then the steering module 234 may cause the car 100 to slow down and/or drive around the deformity 152 or object 154.

If the damage prediction module 232 determines an object 154 looks relatively soft (like a plastic bag, styrofoam, piece of clothing, or cut grass), i.e., low risk of tire damage, then the steering module 234 may decide to steer the car 100 to partially avoid the deformity 152 or object 154, or drive through or over the deformity 152 or object 154.

If the damage prediction module 232 cannot predict an amount of damage, then the module 232 may by default assume an object or deformity will likely cause damage. In another configuration, if the damage prediction module 232 cannot predict an amount of damage, then the module 232 may by default assume an object or deformity will not cause damage.

For example, a puddle of water on a road may seem harmless, or it may have a deep pothole. The objection recognition module 230 may try to determine how deep the puddle of water is based on characteristics (size and shape, clarity of the water, ripples on the surface of water) of the puddle. The damage prediction module 232 may analyze how a car in front of the car 150 reacted to the puddle of water: whether the car in front dipped up and down significantly when it drove through the puddle of water.

### Slow Down to Analyze Object or Deformity

In one configuration, the processor 104 may use the steering and slow down module 234 to slow down the car 100 to give the module 230 more time (e.g., 0.1 to 3 seconds) to analyze and identify an object 154 or deformity 152 on the road 150. For example, if the car 100 is driving at 65 miles per hour (mph) on a freeway at night, when visibility is impaired, the module 230 may detect there is an object 154 on the road 150, but may not identify what the object 154 is immediately. The module 234 may cause the car 100 to slow down (decelerate) smoothly from 65 mph to 60 mph to 55 mph to 50 mph until the module 230 can use data from sensors 102 to more accurately identify the object 154, and the module 232 predicts an amount of damage to the car 100 if the car drives over the object 154.

The predicted damage amount (or risk level) may start at high, then go to medium, then to low as the car 100 drives closer to the object 154, and module 230 analyzes more details of an object 154 on the road 150. For example, as a car 100 is driving, the module 230 first detects an object 154 on the road 150, and the module 232 may assume damage risk is high. The module 234 causes the car 100 to slow down. If the module 230 determines the object 154 is white and has an abnormal shape, and the module 232 may assume damage risk is medium. If the mobile 230 determines the object 154 is a sweatshirt, not a rock or concrete, the module 232 may assume damage risk is low. If the module 232 determines the damage risk of the object 154 is low, then the module 234 may accelerate the car 100 to drive over the object 154 or steer the car 100 around it.

### Self-Driving Mode With Steering and Braking Options

In block 508 of FIG. 5, if the car 100 is in a self-driving mode (also called autonomous driving), the steering and/or slow down module 234 (FIG. 2) may cause the car 100 to:
1) steer the car 100 to avoid the entire deformity 152 or object 154 on the road 150;
2) steer the car 100 to avoid a part of the deformity 152 or object 154 and potentially drive over a part of the deformity 152 or object 154, as described below in more detail below with FIG. 3; and/or
3) slow down the car 100 and steer the car 100 to avoid the entire (or a part of the) deformity 152 or object 154.

FIG. 3 shows an example of the steering module 234 (FIG. 2) directing a front tire 160 of the car 100 (FIG. 1) to swerve slightly to the left, such that the tire 160 drives over a small part of a deformity 152 (such as a pothole) or object 154, and avoids the middle of the deformity 152 or object 154, which may cause more damage to the car tire 160. Since the car tire 160 is wider than the small part of the deformity 152 or object 154, the passengers in the car 100 may not feel any bump or disturbance.

The steering module 234 may select from a number of options (or a continuous range) to steer the car 100 to try avoid hitting the deformity or object on the road, depending on one or more factors:
the speed, size, weight (including the passengers and cargo), and maneuverability of the car 100,
characteristics of the car tires (diameter, width, tread type, tread depth, age, all weather, snow tires), condition of the car 100 (e.g., brakes, shock absorbers),
weather conditions, the condition of the road 150, visibility,
the processing power of the processor 104,
the distance 402 (FIG. 4) to the deformity or object,
the identity 404 of the deformity or object,
the risk level 406 of the deformity or object, and
how much the driver wants a smooth ride vs. swerving to avoid deformities and objects to protect the car components.

For example, if the car 100 is driving at a relatively low speed (e.g., 15-30 mph), then the steering module 234 may have enough time to cause the car 100 to steer away and completely avoid the deformity 152 or object 154.

If the car 100 is driving at a medium speed (e.g., 36-55 mph), the steering module 234 may steer the car to try to avoid hitting most (60% or 75%) of the deformity or object. The steering module 234 may also cause the car to slow down and steer to completely avoid the deformity or object—this may be a configurable setting on the display 110 and configurable by the driver, as described below.

If the car 100 is driving at a high speed (e.g., above 55 mph), the steering module 234 may cause the car 100 to drive over or through the deformity 152 or object 154 if it is safe for the car 100 to do so, or slow down and go around the deformity 152 or object 154.

3 options are described above, but the steering module 234 may select from a continuous range of options, such as for every 1 mph above 35 mph, the processor 104 may try to avoid hitting 1% less than 100% of the deformity or object. For example, if the car 100 is driving 60 mph, then the steering module 234 tries to avoid hitting 100%−25%=75% of the deformity or object. If the car is driving 75 mph, then the steering module 234 tries to avoid hitting 100%−40%=60% of the deformity or object. Thus, when the car 100 is driving faster, the steering module 234 may try to preserve the comfort of the passengers by not braking and/or swerving too much, but there is more risk of the car tires hitting the deformity 152 or object 154.

The damage prediction module 232 in FIG. 2 may predict which part of the deformity 152 or object 154 is relatively safer for a tire 160 of the car 100 to drive over. For example, if the deformity 152 is a pothole, the module 232 may predict a left part of a pothole is safer to drive over, as shown in FIG. 3. As another example, if the object 154 is a tree branch, the module 232 may predict a left part of the tree branch is safer to drive over, as shown in FIG. 3.

FIG. 4 shows a user-configurable setting slider 412 on the display 110. If a driver wants to optimize for a smooth ride 408 (minimize braking and swerving), the driver can move the slider 412 to the left on the bar. If the driver wants to slow down more and/or swerve more 410 to avoid deformities and objects (protects the car tires), the driver can move the slider 412 to the right on the bar.

### Steering Left or Right

The steering module 234 in FIG. 2 may decide to steer the car 100 to the left or the right of the deformity 152 or object 154 depending on one or more factors, such as shape of the deformity 152 or object 154, the location of the deformity 152 or object 154 on the road 150, the location of the car 100 on the road 150 or lane, the width of the road 150 or lane, other cars on the road 150 (and their speeds, distance to the car 100, their predicted motion), weather and road conditions, and other objects on the road 150, such as ice, bicyclists, pedestrians, traffic cones, and debris.

### Display and Speaker

The display 110 in FIGS. 2 and 4 may be implemented on a dashboard, between a driver and a passenger, on a windshield, or on augmented reality glasses.

In FIG. 4, the display 110 may display a warning 400 as a symbol, icon, words, and/or picture. In addition to or instead of a warning message, a speaker 111 in the car 100 may emit a sound to warn the driver about the deformity 152 or object 154 on the road 150. The audible warning sound may be a synthesized voice message (“deformity or object detected”) or a sound, such as a chime.

In FIG. 4, the display 110 may also show a distance 402 to the deformity or object, an identity 404 of the object 154 or deformity 152, and a risk level 406 if the car 100 drives over the identified deformity or object. The software 106 (object recognition or identification module 230 in FIG. 2) on the car 100 (or at a remote server 180) may determine and display the identity 404 of the object 154 or deformity 152.

If the driver is manually driving the car 100, the display 110 may 1) advise the driver to steer the car left or right (as described below) to avoid hitting the deformity 152 or object 154 on the road 150, or 2) offer to autonomously steer the car 100 for the driver with an option 414 on the display 110.

### Find Nearest Tire Retailer or Call for Assistance

If a tire 160 of the car hits a road deformity 152 or object 154, the processor 104 may find the nearest tire retailer to repair or replace a tire 160, and navigate the car 100 to that location. Or the processor 104 may call a service, such as AAA, for roadside assistance via the transceiver 120.

### Multiple Deformities and/or Objects

Car accidents or road construction areas often have multiple deformities and/or objects on the road 150. If the object recognition module 230 and damage prediction module 232 detects multiple deformities and/or objects on the road 150, then the steering module 234 may slow down the car and/or determine the safest path for the car 100 to drive to avoid the most dangerous deformities or objects.

For example, if the object recognition module 230 and damage prediction module 232 detect a rock and a plastic bottle on the road 150, the steering module 234 may decide that is safer for the car tire to drive over the plastic bottle and avoid the rock.

As another example, if the object recognition module 230 detects a 3-foot deep ditch on the right side of the road 150, and broken glass in the middle of the road 150, the steering module 234 may determine that it is unsafe to keep driving, and slow down the car 150. If the module 234 determines it is unsafe to stop the car 150 because of a second car behind the car 100, and if driving over the glass is less dangerous than driving into the ditch, the module 234 may drive the car 100 over the glass.

### Warnings to and/or From Other Cars

In one configuration, the processor 104 and software 106 may operate on the car 100 without receiving data 216 from other devices. In another configuration, the processor 104 and software 106 may receive data 216 (via transceiver 120) about a deformity 152 and/or object 154 from one or more cars in front of the car 100, and/or transmit data 212, 214 (via transceiver 120) about a deformity 152 and/or object 154 to one or more cars behind the car 100. The car 100 may communicate wirelessly via transceiver 120 with a network of cars and computer servers 180.

Each car may have a GPS or other location tracking unit to identify and store the location of the deformity 152 and object 154 on the road 150.

### Speed of Other Cars and Calendar Other Drivers

The processor 104 may receive data 216 that another car (in front or behind car 100) is driving at a high speed because the driver or a passenger is in a rush because he/she is late for a meeting.

### Drone Over the Car

In FIG. 1, the car 100 may have a small drone 170 (launch from the car or other platform) fly above the car 100 (e.g., 20 feet above) and/or in front of car 100 (e.g., 20 feet ahead of the car). The drone 170 may have one or more sensors 102 to detect deformities and/or objects on the road ahead of the car 100 and send data 212 to the car 100.

The drone 170 may detect traffic ahead on the road 150, and the processor 104 may decide to take an alternate route to avoid the traffic.

### Protecting a Windshield

When the processor 104 receives data 112 from sensors 102 and senses a hard object 156 in the air, such as a rock, that is about to hit the windshield of the car 100, the processor 104 may
1) warn the user on the display 110;
2) steer the car 100 to avoid the object;
3) slow the car 100 down;
4) cause one or more devices to deflect the object 156 before the object 156 strikes the windshield.

One device may be one or more air blowers 122 that can hit the object 156 with a burst of air. The one or more air blowers 122 may be located on the windshield, above the windshield, or on the sides of the windshield. The air blower 122 may generate a focused blast of air at the object 156, or generate a shield of air to deflect the object 156.

Instead or in addition to the air blower 122, the processor 104 may operate a windshield wiper on the car 100 to deflect the object 156 before it strikes the windshield.

Instead or in addition to the air blower 122 and windshield wiper, the processor 104 may operate a water sprayer to spray water to deflect the object 156 before it strikes the windshield. The processor 104 may also activate the windshield wipers to remove the water.

The processor 104 may determine a trajectory of the object 156, the size of the object, and where the object 156 will hit the windshield, and then determine whether to use a blast of air, a windshield wiper, and/or a water sprayer to deflect the object 156 before it hits the windshield.

Any of the components described above may be combined, integrated, separated, implemented in hardware and/or software. Any of the components may be replaced with other components known to those of ordinary skill in the art. Other components (known to those of ordinary skill in the art) may be added to the vehicle.

1. A vehicle comprising:
a sensor configured to capture data of a road hazard comprising at least one of a deformity in a road and an object on the road in front of a vehicle;
a processor configured to:
receive the captured data from the sensor of the road hazard;
analyze the road hazard to predict whether the road hazard would damage the vehicle if the vehicle drives over the road hazard; and
if the processor predicts the road hazard would damage the vehicle, steer the vehicle to avoid the road hazard as the vehicle moves forward on the road.

2. The vehicle of claim 1, wherein the vehicle is configured to drive autonomously.

3. The vehicle of claim 1, further comprising a display configured to display a warning to a user in the vehicle of the road hazard if the processor determines the road hazard would damage the vehicle.

4. The vehicle of claim 1, further comprising a display configured to allow a user to select a setting between minimizing disruption of the vehicle driving on the road and maximizing protecting the vehicle from damage if the vehicle drives over the road hazard.

5. An apparatus comprising a processor on a vehicle, the processor being configured to:
receive data from a sensor on the vehicle of a road hazard comprising at least one of a deformity in a road and an object on the road in front of the vehicle;
analyze the road hazard to predict whether the road hazard would damage the vehicle if the vehicle drives over the road hazard; and
if the processor predicts the road hazard would damage the vehicle, steer the vehicle to avoid the road hazard as the vehicle moves forward on the road.

6. The apparatus of claim 5, wherein the processor is configured to use an artificial intelligence algorithm to analyze the road hazard to predict whether the road hazard will damage the vehicle if the vehicle drives over the road hazard.

7. The apparatus of claim 5, wherein the processor is configured to identify the road hazard, which helps the processor predict whether the road hazard will damage the vehicle if the vehicle drives over the road hazard.

8. The apparatus of claim 5, wherein the processor is configured to identify a characteristic of the road hazard, which helps the processor predict whether the road hazard will damage the vehicle if the vehicle drives over the road hazard.

9. The apparatus of claim 5, wherein the processor is further configured to determine a level of risk that a road hazard will damage the vehicle.

10. The apparatus of claim 5, wherein the processor is further configured to change its prediction of whether the road hazard would damage the vehicle as the vehicle drives closer to the road hazard, and the processor receives more data from the sensor of the road hazard.

11. The apparatus of claim 5, wherein the processor is configured to cause the vehicle to drive over a portion of the road hazard if the processor predicts the portion of the road hazard will not significantly damage the vehicle if the vehicle drives over the portion of the road hazard.

12. The apparatus of claim 11, wherein the processor determines a size of the portion of the road hazard to drive over based on a speed of the vehicle.

13. The apparatus of claim 11, wherein the processor determines a size of the portion of the road hazard to drive over based on a user-configured setting between minimizing vehicle disruption and maximizing protecting the vehicle from damage if the vehicle drove over the road hazard.

14. The apparatus of claim 5, wherein the processor is configured to cause the vehicle to decelerate while the processor analyzes data of the road hazard captured by the sensor.

15. The apparatus of claim 5, wherein the processor is configured to cause the vehicle to decelerate before steering the vehicle to avoid the road hazard as the vehicle moves forward on the road.

16. The apparatus of claim 5, wherein the processor is configured to use data from a previous road hazard that the vehicle previously drove over to predict whether the current road hazard would damage the vehicle if the vehicle drove over the current road hazard.

17. The apparatus of claim 5, wherein the processor is configured to use data from another vehicle to predict whether the road hazard would damage the vehicle if the vehicle drives over the road hazard.

18. A method comprising:
receiving data from a sensor on a vehicle of a road hazard comprising at least one of a deformity in a road and an object on the road in front of the vehicle as the vehicle moves forward on the road;
analyzing the road hazard to predict whether the road hazard would damage the vehicle if the vehicle drives over the road hazard; and
if the processor predicts the road hazard would damage the vehicle, steering the vehicle to avoid the road hazard as the vehicle moves forward on the road.

19. The method of claim 18, further comprising identifying the road hazard.

20. The method of claim 18, further comprising displaying a warning to a user in the vehicle of the road hazard if the processor determines the road hazard would damage the vehicle.
